(19) United States
(12) Patent Application Publication
(10) Pub. No.: US 2010/0212324 A1
(43) Pub. Date: Aug. 26, 2010

(54) DUAL WALLED COMBUSTORS WITH IMPINGEMENT COOLED IGNITERS

(75) Inventors: Thomas J. Bronson, Mesa, AZ (US); Nagaraja Rudrapatna, Chandler, AZ (US); Jon Kettinger, Litchfield Park, AZ (US); Frank Joseph Zupanc, Phoenix, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/393,729

(22) Filed: Feb. 26, 2009

(51) Int. Cl. F02C 7/22; F02C 7/264

(52) U.S. Cl. 60/752; 60/39.821

(57) ABSTRACT

A combustor for a gas turbine engine includes an inner liner and an outer liner circumscribing the inner liner and forming a combustion chamber with the inner liner. The outer liner is a dual walled liner with a first wall and a second wall. The combustor includes a fuel igniter comprising a tip portion configured to ignite an air and fuel mixture in the combustion chamber and an igniter tube positioning the fuel igniter relative to the combustion chamber. The igniter tube includes a plurality of holes configured to direct cooling air toward the tip portion of the fuel igniter.

### FIELD OF THE INVENTION

The following description generally relates to combustors for gas turbine engines, and more particularly relates to combustors with impingement cooled igniters and igniter tubes for improved cooling of igniters.

### BACKGROUND

A gas turbine engine may be used to power various types of vehicles and systems. A particular type of gas turbine engine that may be used to power aircraft is a turbofan gas turbine engine. A turbofan gas turbine engine conventionally includes, for example, five major sections: a fan section, a compressor section, a combustor section, a turbine section, and an exhaust section. The fan section is typically positioned at the front, or “inlet” section of the engine, and includes a fan that induces air from the surrounding environment into the engine and accelerates a fraction of this air toward the compressor section. The remaining fraction of air induced into the fan section is accelerated into and through a bypass plenum and out the exhaust section.

The compressor section raises the pressure of the air it receives from the fan section to a relatively high level. The compressed air from the compressor section then enters the combustor section, where a ring of fuel nozzles injects a steady stream of fuel into a combustion chamber formed between inner and outer liners. The fuel and air mixture is ignited to form combustion gases.

Known combustors include inner and outer liners that define an annular combustion chamber in which the fuel and air mixtures are combusted. The inner and outer liners are spaced radially inwardly from a combustor casing such that inner and outer passageways are defined between the respective inner and outer liners and the combustor casing. Fuel igniters extend through the combustor casing and the outer passageway, and are coupled to the outer liner by igniter tubes attached to the combustor liner. More specifically, the fuel igniter tubes secure and maintain the igniters in alignment relative to the combustion chamber as well as provide a sealing interface for the igniter between the outer passageway and the combustion chamber.

During operation, a portion of the airflow entering the combustor is channeled through the combustor outer passageway for attempting to cool the outer liner and igniters and diluting a main combustion zone within the combustion chamber. However, over time, continued operation may induce potentially damaging thermal stresses into the combustor that exceed the strength of materials used in fabricating the components of the combustor. For example, thermally induced transient and steady state stresses may cause low cycle fatigue (LCF) failure of the igniter.

Cooling the igniter, particularly the tip portion of the igniter closest to the combustion process, frequently presents challenges. Some conventional igniters include a plurality of longitudinal slots extending down the length of the igniter to channel cooling air to the vicinity of the tip portion of the igniter. However, this arrangement is generally not very efficient because it typically requires a relatively large amount of cooling air to sufficiently cool the tip portion of the igniter. The large amount of air used to effectively cool the tip portion of the igniter in this manner may adversely impact the combustion conditions within the combustion chamber. Particularly, a large amount of cooling air may have a perturbative effect on the ignition process, gaseous emissions, and the temperature distribution of hot gases entering the turbine. In some arrangements, the quantity and manner in which cooling air is admitted into the combustor may result in a barrier formed around the igniter that prevents fuel from reaching the tip portion of the igniter. This can additionally reduce the effectiveness of the igniter for igniting the fuel and air mixture. Moreover, excess cooling air can disrupt the liner cooling film and result in local hot spots immediately downstream of the igniter in the combustor liner.

In a dual walled combustor, the challenges involved in cooling the igniter are exacerbated. For example, the respective walls and other components may move relative to one another during operation, which should be considered by a combustor designer. Moreover, additional walls require additional sealing arrangements and more complicated paths for the cooling air to reach the igniter tip.

Accordingly, it is desirable to provide combustors with igniters that are efficiently cooled without adversely interfering with the combustion of the air and fuel mixtures in the combustion chamber. In addition, it is desirable to provide igniter tubes for improved cooling of igniters in combustors. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a combustor for a gas turbine engine includes an inner liner and an outer liner circumscribing the inner liner and forming a combustion chamber with the inner liner. The outer liner is a dual walled liner with a first wall and a second wall. The combustor includes a fuel igniter comprising a tip portion configured to ignite an air and fuel mixture in the combustion chamber and an igniter tube positioning the fuel igniter relative to the combustion chamber. The igniter tube includes a plurality of holes configured to direct cooling air toward the tip portion of the fuel igniter.

In accordance with another exemplary embodiment, an igniter tube for positioning a fuel igniter with respect to an outer liner of a dual walled combustor includes an igniter boss assembly. The igniter boss assembly includes a cold boss configured to be mounted on the first wall of the outer liner and including a first set of holes, and a hot boss configured to be mounted on the second wall of the outer liner and including a second set of holes. The cold boss and hot boss are arranged to form a cavity therebetween such that cooling air flows through the first set of holes, through the cavity, through the second set of holes and impinge upon the fuel igniter.

In accordance with yet another exemplary embodiment, a combustor for a gas turbine engine includes an inner liner; an outer liner circumscribing the inner liner and forming a combustion chamber with the inner liner, the outer liner being a dual walled liner with a first wall and a second wall; a fuel igniter comprising a tip portion configured to ignite an air and fuel mixture in the combustion chamber; and an igniter tube positioning the fuel igniter relative to the combustion chamber. The igniter tube may have a plurality of holes configured to direct cooling air toward the tip portion of the fuel igniter in a perpendicular direction to a longitudinal axis of the fuel igniter. The igniter tube may include a cold boss mounted to the first wall and a hot boss mounted to the second wall, and the hot boss and cold boss may define a cavity therebetween. The plurality of holes may include a first set of holes in the cold boss and a second set of holes in the hot boss. The cold boss and hot boss may be arranged such that cooling air flows through the first set of holes, through the cavity, and through the second set of holes to impingement upon the tip portion.

### BRIEF DESCRIPTION OF THE DRAWINGS

The present invention will hereinafter be described in conjunction with the following drawing figures, wherein like numerals denote like elements, and wherein:

FIG. 1 is a cross-sectional view of a gas turbine engine in accordance with an exemplary embodiment;

FIG. 2 is a cross-sectional view of a combustor for the gas turbine engine of FIG. 1 in accordance with an exemplary embodiment;

FIG. 3 is an enlarged isometric cross-sectional view of an igniter and igniter tube suitable for use in the combustor of FIG. 2 in accordance with an exemplary embodiment;

FIG. 4 is an isometric view of a hot boss of the igniter tube of FIG. 3 in accordance with an exemplary embodiment; and

FIG. 5 is an isometric view of a cold boss of the igniter tube of FIG. 3 in accordance with an exemplary embodiment.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Broadly, exemplary embodiments discussed herein relate to dual walled combustors. More particularly, the dual walled combustor includes an igniter tube that mounts an igniter to an outer liner of a combustion chamber. The igniter tube has a number of holes that direct cooling impingement air onto a tip portion of the igniter. For example, the igniter tube may include a hot boss mounted on the inner wall of the liner with a first set of holes and a cold boss mounted on the outer wall of the liner with a second set of holes. The hot and cold bosses may be arranged such that cooling air enters the second set of holes, flows through a cavity between the hot and cold bosses, flows through the first set of holes, and impinges on the igniter tip.

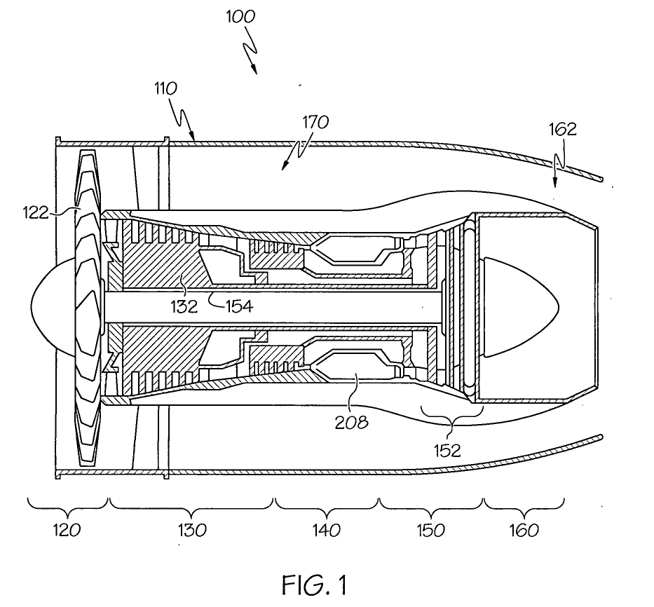

FIG. 1 is a simplified, cross-sectional view of a gas turbine engine 100, according to an embodiment. In an exemplary embodiment, the gas turbine engine 100 can form part of, for example, an auxiliary power unit for an aircraft or a propulsion system for an aircraft. The engine 100 may be disposed in an engine case 110 and may include a fan section 120, a compressor section 130, a combustion section 140, a turbine section 150, and an exhaust section 160. The fan section 120 may include a fan 122, which draws in and accelerates air. A fraction of the accelerated air exhausted from the fan 122 is directed through a bypass section 170 to provide a forward thrust. The remaining fraction of air exhausted from the fan 122 is directed into the compressor section 130.

The compressor section 130 may include a series of compressors 132, which raise the pressure of the air directed into it from the fan 122. The compressors 132 may direct the compressed air into the combustion section 140. In the combustion section 140, which includes an annular combustor 208, the high pressure air is mixed with fuel and combusted. The combusted air is then directed into the turbine section 150.

The turbine section 150 may include a series of turbines 152, which may be disposed in axial flow series. The combusted air from the combustion section 140 expands through the turbines 152 and causes them to rotate. The air is then exhausted through a propulsion nozzle 162 disposed in the exhaust section 160, providing additional forward thrust. In an embodiment, the turbines 152 rotate to thereby drive equipment in the engine 100 via concentrically disposed shafts or spools. Specifically, the turbines 152 may drive the compressor 132 via one or more rotors 154.

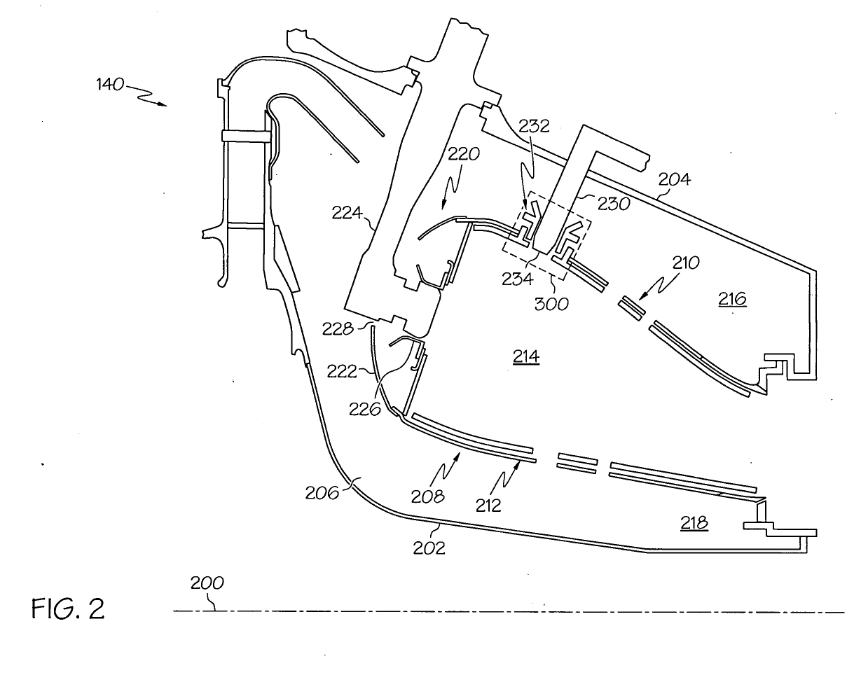

FIG. 2 is a more detailed cross-sectional view of the combustion section 140 of FIG. 1. In FIG. 2, only half the cross-sectional view is shown, the other half substantially rotationally symmetric about a centerline and axis of rotation 200. Although the depicted combustion section 140 is an annular-type combustion section, any other type of combustor, such as a can combustor, can be provided.

The combustion section 140 comprises a radially inner case 202 and a radially outer case 204 concentrically arranged with respect to the inner case 202. The inner and outer cases 202, 204 circumscribe the axially extending engine centerline 200 to define an annular pressure vessel 206. As noted above, the combustion section 140 also includes the combustor 208 residing within the annular pressure vessel 206. The combustor 208 is defined by an outer liner 210 and an inner liner 212 that is circumscribed by the outer liner 210 to define an annular combustion chamber 214. The liners 210, 212 cooperate with cases 202, 204 to define respective outer and inner air plenums 216, 218.

The combustor 208 includes a front end assembly 220 comprising a shroud assembly 222, fuel injectors 224, and fuel injector guides 226. One fuel injector 224 and one fuel injector guide 226 are shown in the partial cross-sectional view of FIG. 2. In one embodiment, the combustor 208 includes a total of sixteen circumferentially distributed fuel injectors 224, but it will be appreciated that the combustor 208 could be implemented with more or less than this number of injectors 224. Each fuel injector 224 is secured to the outer case 204 and projects through a shroud port 228. Each fuel injector 224 introduces a swirling, intimately blended fuel and air mixture that supports combustion in the combustion chamber 214.

A fuel igniter 230 extends through the outer case 204 and the outer plenum 216, and is coupled to the outer liner 210. It will be appreciated that more than one igniter 230 can be provided in the combustor 208, although only one is illustrated in FIG. 2. The igniter 230 is arranged downstream from the fuel injector 224 and is positioned to ignite the fuel and air mixture within the combustion chamber 214.

The igniter 230 is coupled to outer liner 210 by an igniter tube 232. More specifically, the igniter tube 232 is coupled within an opening 234 extending through outer liner 210, such that the igniter tube 232 is concentrically aligned with respect to the opening 234 of the outer liner 210. The igniter tube 232 maintains the alignment of the igniter 230 relative to the combustor 208. In one embodiment, the opening 234 of the outer liner 210 and the igniter tube 232 have substantially circular cross-sectional profiles. The igniter tube 232 is discussed in greater detail below.

During engine operation, airflow exits a high pressure diffuser and deswirler at a relatively high velocity and is directed into the annular pressure vessel 206 of the combustor 208. The airflow enters the combustion chamber 214 through openings in the liners 210, 212, where it is mixed with fuel from the fuel injector 224, and the airflow is combusted after being ignited by the igniter 230. The combusted air exits the combustion chamber 214 and is delivered to the turbine section 150 (FIG. 1).

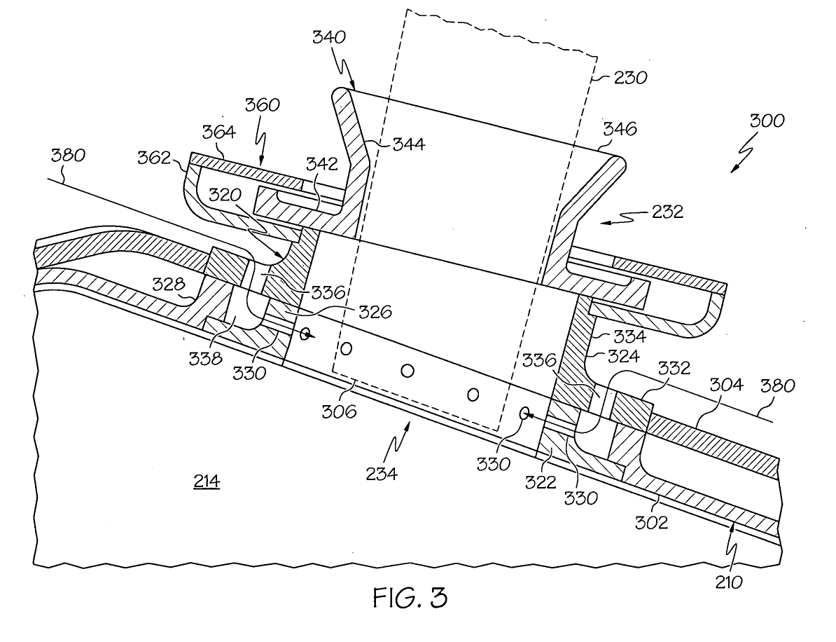

FIG. 3 is an enlarged isometric cross-sectional view, represented by the dashed box 300 of FIG. 2, of the igniter tube 232 coupled to the outer liner 210. As most clearly shown in FIG. 3, the outer liner 210 is a dual wall liner with a first, inner wall 302 and a second, outer wall 304 that may increase the cooling effects of the combustor walls. Typically, in a dual wall configuration, the inner wall 302 includes a number of cooling tiles or heat shields. This improved cooling may lead to additional air available for the combustion process and a corresponding decrease in unwanted emissions. The inner liner 212 (FIG. 1) may also be a dual wall liner.

In FIG. 3, the igniter 230 has been removed although its approximate position is indicated with dashed lines. As noted above, the igniter tube 232 mounts the igniter 230 in the combustor 208, and particularly mounts the igniter 230 such that a tip portion 306 of the igniter 230 is exposed to the fuel and air mixture in the combustion chamber 214. The tip portion 306 may be slightly recessed, slightly protruding, or nominally flush with the inner surface of the outer liner 210. The igniter tube 232 includes an igniter boss assembly 320, a grommet 340, and a supporting ring 360 extending therebetween. The igniter tube 232 will be typically manufactured from a material similar to that outer liner 210, which is capable of withstanding the temperatures within the combustion chamber 214.

The igniter boss assembly 320 mounts the igniter tube 232 to the outer liner 210. In particular, the igniter boss assembly 320 includes a hot boss 322 that mounts the igniter tube 232 to the inner wall 302 of the outer liner 210 and a cold boss 324 that mounts the igniter tube 232 to the outer wall 304 of the outer liner 210.

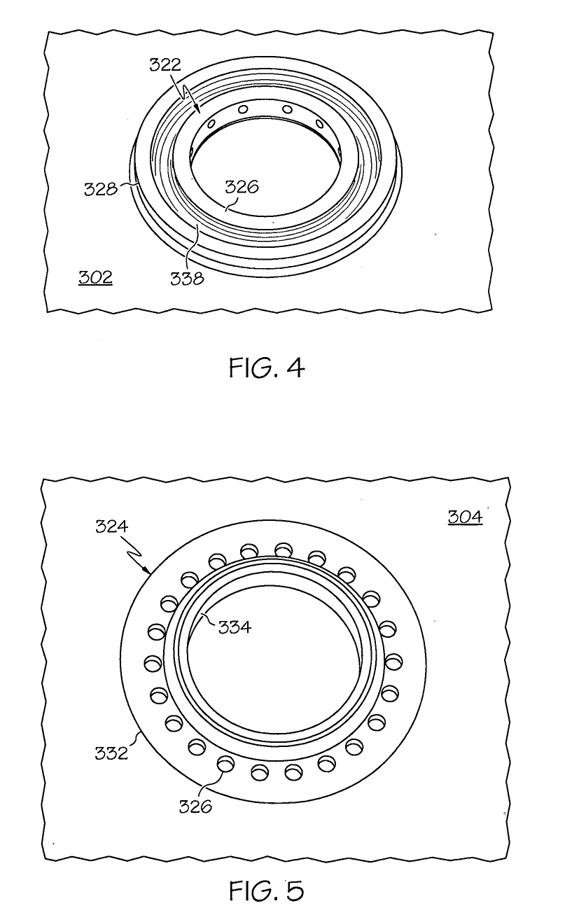

The hot boss 322 is more particularly shown in the top, isometric view of FIG. 4, which shows the hot boss 322 mounted on the inner wall 302 with the other components omitted. Referring to both FIGS. 3 and 4, the hot boss 322 includes a first flange 326 that extends in a generally parallel direction to the igniter 230 and generally perpendicular to the opening 234. The first flange 326 of the hot boss 322 cooperates with a second flange 328 of the inner wall 302 to define a cavity 338. The first flange 326 includes a number of impingement holes 330 that extend in a generally radial direction relative the igniter 230. In one exemplary embodiment, the hot boss 322 is manufactured separately and mounted onto the inner wall 302, for example, by welding. In another exemplary embodiment, the hot boss 322 is integral and manufactured with the inner wall 302.

The cold boss 324 is more particularly shown in the top, isometric view of FIG. 5, which shows the cold boss 324 mounted on the outer wall 304 with the other components omitted. Referring to both FIGS. 3 and 5, the cold boss 324 includes a first portion 332 and a second portion 334 extending essentially perpendicular to the first portion 332. The first portion 332 mounts the cold boss 324 to the outer wall 304 and at least partially covers the cavity 338 associated the hot boss 322. The first portion 332 of the cold boss 324 includes a number of feed holes 336 that extend in a generally parallel direction to the igniter 230. As discussed in greater detail below, air from the plenum 216 (FIG. 2) flows through the feed holes 336, into the cavity 338, and through impingement holes 330 to cool the tip portion 306 of the igniter 230.

In the exemplary embodiment, the igniter boss assembly 320 has a substantially circular outer diameter corresponding to a diameter of the opening 234 of the outer liner 210. In various embodiments, the igniter boss assembly 320 is mounted onto a surface of the outer liner 210 with adhesive, welding, screws, or any other suitable mechanism that provides an adequate sealing interface, or portions of the igniter boss assembly 320 may be integral with portions of the outer liner 210.

Returning to FIG. 3, the supporting ring 360 of the igniter tube 232 includes a ring portion 362 and a cover portion 364. The ring portion 362 of the supporting ring 360 is coupled to the igniter boss assembly 320. The ring portion 362 extends generally perpendicularly and radially outwardly from the second portion 334 of the cold boss 324 of the igniter boss assembly 320. In alternate embodiments, all or portions the supporting ring 360 are integral with the igniter boss assembly 320 and/or directly coupled to the inner liner 210.

The grommet 340 of the igniter tube 232 includes a mounting portion 342 and a tube portion 344 that extends substantially perpendicular from the mounting portion 342. The mounting portion 342 is received between the ring portion 362 and the cover portion 364 to be substantially retained by the supporting ring 360. An outside diameter of the mounting portion 342 of the grommet 340 is less than an inside diameter of the ring portion 362 of the supporting ring 360. As a result of this arrangement, the grommet 340 may be able to move laterally with respect to the supporting ring 360 to accommodate manufacturing tolerances and movements during operation. In an alternate embodiment, the grommet 340 is fixed to the supporting ring 360 and not movable laterally relative to the supporting ring 360, or in a further alternate embodiment, the grommet 340 is directly coupled to the igniter boss assembly 320 and the supporting ring 360 is omitted. The tube portion 344 includes a radially divergent portion that defines an insertion opening 346. The insertion opening 346 has a diameter at an outer end that is larger than an inside diameter. Accordingly, the grommet 340 can guide the igniter 230 into the igniter tube 232 such that the tip portion 306 of the igniter tube 232 extends into the combustion chamber 214. The igniter tube 232 secures the igniter 230 and maintains the igniter 230 in alignment relative to the combustor 208 (FIG. 1). As noted above, although the illustrated embodiment illustrates the supporting ring 360, the grommet 340, and the igniter boss assembly 320 as separate pieces, and in an alternate embodiment, one or more of the supporting ring 360, the grommet 340, and the igniter boss assembly 320 can be integral with one another.

As noted above, the igniter tube 232 defines a number of holes 330, 336 for directing air to the igniter 230. In the illustrated embodiment, air from the plenum 216 (FIG. 2) flows through the feed holes 336, into the cavity 338, and through impingement holes 330 to the tip portion 306 of the igniter 230, as indicated by flows 380. The flows 380 directly impinge the igniter 230 mounted by the igniter tube 232 and cools the igniter 230. The flows 380 can particularly be directed to, and cool, the tip portion 306 of the igniter 230. In the illustrated embodiment, the flows 380 impinge on the igniter 230 in essentially perpendicular direction to the longitudinal axis of the igniter 230, although it can be appreciated that other angles can be provided to cool the igniter tip 118 of the igniter 230.

In one embodiment, the pressure drop through the impingement holes 330 is relatively high to provide efficient impingement cooling. As such, the pressure drop through the feed holes 336 and the cavity 338 should be relatively small. In one embodiment, this is accomplished by having the total area of the feed holes 336 be greater than the total area of the impingement holes 330. For example, the ratio of area between the feed holes 336 and the impingement holes 330 can be about 4:1 or greater. In one embodiment, 4:1 ratio results in about 6% of the pressure drop across the feed holes, 94% across the impingement holes. Other pressure drops may also be provided. The exemplary combination of the feed holes 336, cavity 338, and impingement holes 330 provide impingement cooling within a dual wall combustor 208, which as discussed above, includes consideration of relative movement of components, additional sealing requirements, and achieving impingement at a greater igniter tip depth, particularly when compared to a single wall combustor.

Some igniters 230 may have jackets (not shown) completely or partially covering the tip portion 306 of the igniter 230. In these arrangements, the jacket can be at least partially removed to allow access of the cooling air to the tip portion 306 of the igniter 230.

In general, the igniter tube 232 can have any structural arrangement and combination of holes 330, 336 that enables the flows 380 to impinge on or proximate to the tip portion 306 of the igniter 230. The holes 330, 336 in the igniter tube 232 that direct the flows 380 can be circular in diameter and circumferentially aligned about the igniter 230. The feed holes 336 and the impingement holes 330 do not have to be the same size and/or shape. For example, one set of holes 330, 336 can be larger than the other set of holes 330, 336 to facilitate alignment. In alternate embodiments, the holes 330, 336 can be U-shaped indentions such that, for example, the feed holes 336 are formed when the first portion 332 abuts second portion 334 and/or the impingement holes 330 are formed when the first flange 326 of the hot boss 322 abuts the underside of the cold boss 324.

In an exemplary embodiment, the flows 380 through the igniter tube 232 can cool the tip portion 306 of the igniter 230 to temperatures less than, for example, 1500° F. In another exemplary embodiment, the flows 380 through the igniter tube 232 can cool the tip portion 306 of the igniter 230 to temperatures such as, for example, 1200° F. Exemplary arrangements enable placement of the tip portion 306 within or proximate to the combustion chamber 214, which has particularly been a difficult issue in conventional dual wall combustors.

Impingement cooling is more effective than conventional mechanisms, such as slot cooling, for cooling the igniter, and therefore, a reduced amount of air can be used to effectively cool the igniter 230. In one exemplary embodiment, the amount of air necessary to cool the igniter 230 in the combustor 208 is one third or one fourth of the amount of air necessary to cool igniters in conventional combustors. By reducing the amount of necessary flows 380 through the igniter tube 232, the function of the igniter 230 and/or the combustion conditions in the combustion chamber 214 are not adversely affected. In one exemplary embodiment, there are 22 feed holes 336 with a diameter of approximately 0.062 inches and 12 impingement holes 330 with a diameter of about 0.042 inches. A greater or fewer number of holes 330, 336 can be provided, as well as different sizes. Different configurations and arrangements of the igniter tube 232 can be provided as necessary in dependence on the desired temperature of the igniter 230 and the sensitivity of the combustor 208 to additional cooling air. Reduced temperatures in the igniter 230 results in lower thermal stresses and improved life in a cost-effective and reliable manner.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A combustor for a gas turbine engine, comprising:
an inner liner;
an outer liner circumscribing the inner liner and forming a combustion chamber with the inner liner, the outer liner being a dual walled liner with a first wall and a second wall;
a fuel igniter comprising a tip portion configured to ignite an air and fuel mixture in the combustion chamber; and
an igniter tube positioning the fuel igniter relative to the combustion chamber, the igniter tube having a plurality of holes configured to direct cooling air toward the tip portion of the fuel igniter.

2. The combustor of claim 1, wherein the plurality of holes is configured to direct air perpendicularly to a longitudinal axis of the fuel igniter.

3. The combustor of claim 1, wherein the igniter tube includes a cold boss mounted on the first wall and a hot boss mounted on the second wall.

4. The combustor of claim 3, wherein the hot boss and cold boss define a cavity therebetween, the plurality of holes including a first set of holes in the cold boss and a second set of holes in the hot boss, the cold boss and hot boss being arranged such that cooling air flows through the first set of holes, through the cavity, and through the second set of holes to impinge upon the tip portion.

5. The combustor of claim 4, wherein the fuel igniter has a longitudinal axis, and wherein the first set of holes are arranged generally parallel to the longitudinal axis and the second set of holes are arranged generally perpendicular to the longitudinal axis.

6. The combustor of claim 4, wherein the first set of holes has a first total area and the second set of holes has a second total area, the first total area being greater than the second total area.

7. The combustor of claim 6, wherein the ratio of first total area to second total area is about 4:1.

8. The combustor of claim 1, wherein the igniter tube includes
an annular igniter boss assembly coupled to the outer liner,
a supporting ring coupled to the igniter boss assembly, and
a grommet coupled to the supporting ring and configured to receive the fuel igniter.

9. The combustor of claim 8, wherein the grommet is configured to move laterally with respect to the supporting ring.

10. The combustor of claim 9,
wherein the supporting ring comprises a ring portion and a cover portion, and
wherein the grommet comprises a mounting portion that is axially retained by, and laterally movable relative to, the ring and cover portions of the supporting ring.

11. The combustor of claim 8, wherein the grommet comprises diverging portions for guiding the fuel igniter into the igniter tube.

12. The combustor of claim 1, wherein the plurality of holes is configured to direct a volume of cooling air sufficient to cool the tip portion of the fuel igniter to less than 1500° F.

13. An igniter tube for positioning a fuel igniter with respect to an outer liner of a dual walled combustor, the outer liner having a first wall and a second wall, the igniter tube comprising:
an igniter boss assembly comprising
a cold boss configured to be mounted on the first wall of the outer liner and including a first set of holes, and
a hot boss configured to be mounted on the second wall of the outer liner and including a second set of holes, the cold boss and hot boss being arranged to form a cavity therebetween such that cooling air flows through the first set of holes, through the cavity, through the second set of holes and impinge upon the fuel igniter.

14. The igniter tube of claim 13, wherein the second set of holes are configured to direct air perpendicularly toward a longitudinal axis of the fuel igniter.

15. The igniter tube of claim 13, wherein the fuel igniter has a longitudinal axis, and wherein the first set of holes are arranged generally parallel to the longitudinal axis and the second set of holes are arranged generally perpendicular to the longitudinal axis.

16. The igniter tube of claim 13, wherein the first set of holes has a first total area and the second set of holes has a second total area, the first total area being greater than the second total area.

17. The igniter tube of claim 16, wherein the ratio of first total area to second total area is about 4:1.

18. The igniter tube of claim 13, further comprising
a supporting ring coupled to the igniter boss assembly, and
a grommet coupled to the supporting ring and configured to receive the fuel igniter.

19. The igniter tube of claim 13, wherein the grommet is configured to move laterally with respect to the supporting ring.

20. A combustor for a gas turbine engine, comprising:
an inner liner;
an outer liner circumscribing the inner liner and forming a combustion chamber with the inner liner, the outer liner being a dual walled liner with a first wall and a second wall;
a fuel igniter comprising a tip portion configured to ignite an air and fuel mixture in the combustion chamber; and
an igniter tube positioning the fuel igniter relative to the combustion chamber, the igniter tube having a plurality of holes configured to direct cooling air toward the tip portion of the fuel igniter in a perpendicular direction to a longitudinal axis of the fuel igniter, wherein the igniter tube includes a cold boss mounted to the first wall and a hot boss mounted to the second wall, wherein the hot boss and cold boss define a cavity therebetween, the plurality of holes including a first set of holes in the cold boss and a second set of holes in the hot boss, the cold boss and hot boss being arranged such that cooling air flows through the first set of holes, through the cavity, and through the second set of holes to impingement upon the tip portion.
